(19) United States
(12) Patent Application Publication
(10) Pub. No.: US 2007/0285260 A1
(43) Pub. Date: Dec. 13, 2007

(54) Method, device, and computer product for detecting emergency

(75) Inventor: Hiromi Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/583,111

(22) Filed: Oct. 19, 2006

(30) Foreign Application Priority Data
Jun. 12, 2006 (JP) 2006-162850

(51) Int. Cl. G08B 23/00; G08B 1/08

(52) U.S. Cl. 340/573.4; 340/539.13

(57) ABSTRACT

A mobile station is carried by a child. The mobile station fetches current location data and step data of the child, compares the fetched location data and the step data with past data, and determine whether a child is facing an emergency. If the child is facing an emergency, the mobile station notifies that the child is facing an emergency to a contact address of the child.

### BACKGROUND OF THE INVENTION

1. Field of the Invention

The present invention relates to detecting whether a person is in danger.

2. Description of the Related Art

Recently, incidents involving children, such as kidnapping of children during commutation to and from a school, are occurring frequently and have become a social evil. Various systems are suggested for overcoming such an evil and to protect the children's safety. A help request type system, a monitoring type system, and an activity range type system are sequentially explained as examples of such systems.

In the help request type system, an emergency mechanism (an emergency button or an emergency switch etc.) is included in a mobile station (for example, a mobile phone etc.) such that during an emergency, a child can activate the emergency mechanism to emit a light or a sound and attract attention of the surrounding people. Further, during the emergency, an emergency notification is sent to a prior recorded contact address (for example, a telephone number and a email address of a guardian etc.).

In the monitoring type system, by using a Global Positioning System (GPS) function of the mobile station that protects the child, the guardian can read a current location data of the child from a remote distance and can grasp whereabouts of the child from home.

In the activity range type system, data such as predetermined route data, for example, route data from the home to the school (the location data according to the GPS and a base station identification (ID)) and estimated time etc. are stored in a planned activity database that is included in the mobile station. The mobile station fetches a current time and the location data during a time period from when the child leaves the home until the child reaches a destination such as the school. As a result of a comparison by a comparing unit, whereabouts of the child according to the location data are viewable to the guardian only if the stored location data differs from the location data of the planned activity database. The mobile station can operate in a prior set area (the location data according to the GPS and the base station ID) that is treated as “safe”, and if the mobile station is outside the prior set area, a notification to the effect is sent to the guardian.

In a technology disclosed in Japanese Patent Application Laid-open No. 2004-361363, a user's movement status (whether the user is inside an airplane, driving a car, walking etc.) is determined by using pressure sensors included inside the user's shoes and the GPS function, and a route guidance according to the movement status is carried out.

However, the aforementioned conventional technology includes the following drawbacks. Drawbacks in the help request type system, the monitoring type system, and the activity range type system are sequentially explained.

In the help request type system, the child may not be able to operate the emergency mechanism of the mobile station and seek help during occurrence of an unforeseen emergency. Thus, a system is necessary that is autonomous and does not depend on activation of the emergency mechanism by the child.

In the monitoring type system, because a condition of the child can become known only due to the guardian's action, the guardian may not be able to immediately grasp the condition of the child during occurrence of an unforeseen emergency. Thus, a system is needed that is usable in real time and that can immediately set an alarm during occurrence of an emergency.

The activity range type system is autonomous and usable in real time. However, the activity range type system restricts a range of the activities of the child and further regulates the activities according to time. Although the activity range type system is effective for activities in a predetermined range such as daily commutation to the school, if the activities of the child are outside the permitted activity range or if the activities are carried out during a time period that is outside the estimated time, the activity range type system cannot function at all. Because the activity range in the child's living environment cannot be restricted, a system is called for that enables free activities of the child without restricting the activity range or regulating the activities according to time.

### SUMMARY OF THE INVENTION

It is an object of the present invention to at least partially solve the problems in the conventional technology.

According to an aspect of the present invention, an emergency detecting device that detects an emergency faced by a monitored person includes a fetching unit that fetches location data that indicates current location of the monitored person and step data that indicates a number of steps of the monitored person; and a determining unit that determines whether the monitored person is facing an emergency based on the location data and the step data.

According to another aspect of the present invention, a method of detecting an emergency faced by a monitored person includes fetching location data that indicates current location of the monitored person and step data that indicates a number of steps of the monitored person; and determining whether the monitored person is facing an emergency based on the location data and the step data.

According to another aspect of the present invention, a computer-readable recording medium stores therein a computer program that causes a computer to implement the above method.

According to still another aspect of the present invention, a control circuit for use in an emergency detecting device that detects an emergency faced by a monitored person includes a fetching unit that fetches location data that indicates current location of the monitored person and step data that indicates a number of steps of the monitored person; and a determining unit that determines whether the monitored person is facing an emergency based on the location data and the step data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an outline and a salient feature of an embodiment of the present invention;

FIG. 2 is a functional block diagram of a structure of a mobile station according to the embodiment;

FIG. 3 is an example of contents of past data that is stored in a past-data storage unit shown in FIG. 2;

FIG. 4 is an example of contents of contact address data that is stored in a contact-address storage unit shown in FIG. 2;

FIG. 5 is a flowchart of a process procedure performed by the mobile station; and

FIG. 6 depicts a hardware structure of a computer that implements the mobile station shown in FIG. 2 as software.

### DETAILED DESCRIPTION OF THE PREFERRED EMBODIMENTS

Exemplary embodiments according to the present invention are explained below in detail with reference to the accompanying drawings.

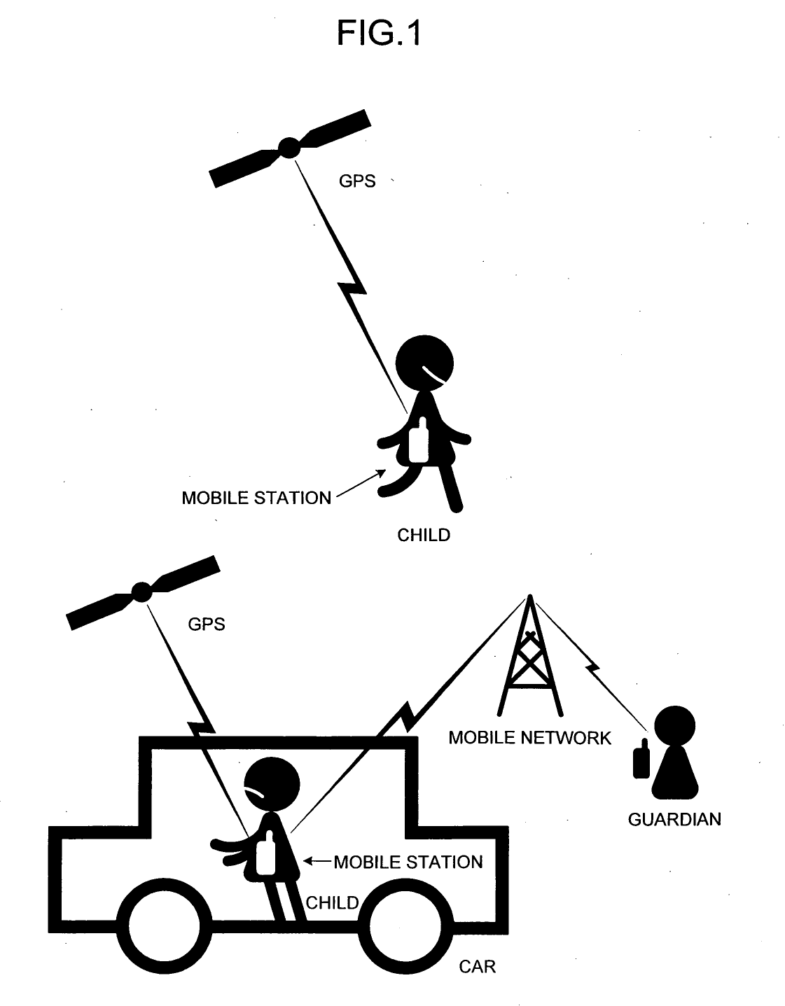

An outline and a salient feature according to an embodiment of the present invention are explained first. FIG. 1 is a schematic of the outline and the salient feature according to the embodiment. A mobile station, which can be a mobile phone, according to the embodiment is attached to, or carried by, a monitored person. A child has been shown in FIG. 1 as the monitored person. The mobile station uses a Global Positioning System (GPS) function to fetch data of a location (hereinafter, “location data”) of the child and data of a number of steps (hereinafter, “step data”) of the child, and based on the fetched location data and the step data determines whether the child is facing an emergency.

As shown in an upper portion of FIG. 1, when the two conditions that the mobile station is moving and the child is walking are satisfied, the mobile station determines that the child is not facing an emergency.

As shown in a lower portion of FIG. 1, when the two conditions that the mobile station is moving and the child is not walking, the mobile station determines that the child is facing an emergency. If the mobile station is moving but the child is not walking, it could mean that the child has been kidnapped and being carried in a car or the like. Upon determining that the child is facing an emergency, the mobile station notifies that the child is facing an emergency to an emergency contact address. The emergency contact address can be a mobile terminal of a guardian of the child or house telephone of the child.

Thus, based on the location data and the step data of the child, the mobile station determines whether the child is facing an emergency, and upon determining that the child is facing an emergency notifies the data to the effect that the child is facing an emergency. Thus, the mobile station enables free activities of the child, and if the child in danger, the mobile station can immediately notify the guardian of the emergency faced by the child and can protect the child's safety.

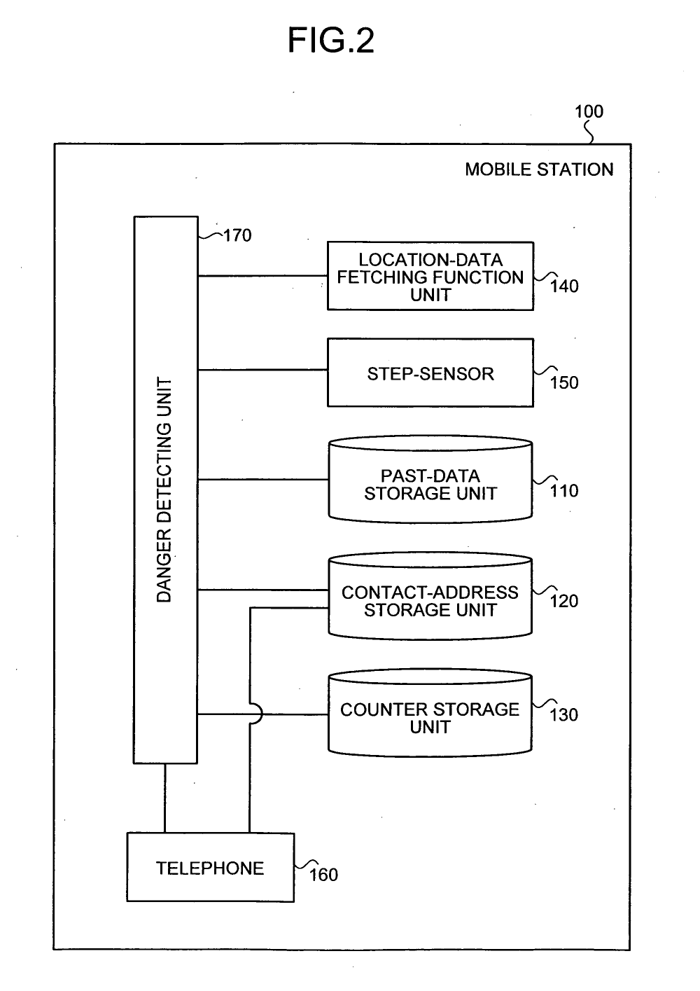

Next, a structure of the mobile station is explained below. FIG. 2 is a functional block diagram of a mobile station 100 according to the embodiment. The mobile station 100 includes a past-data storage unit 110, a contact-address storage unit 120, a counter storage unit 130, a location-data fetching unit 140, a step sensor 150, a telephone 160, and a danger detecting unit 170.

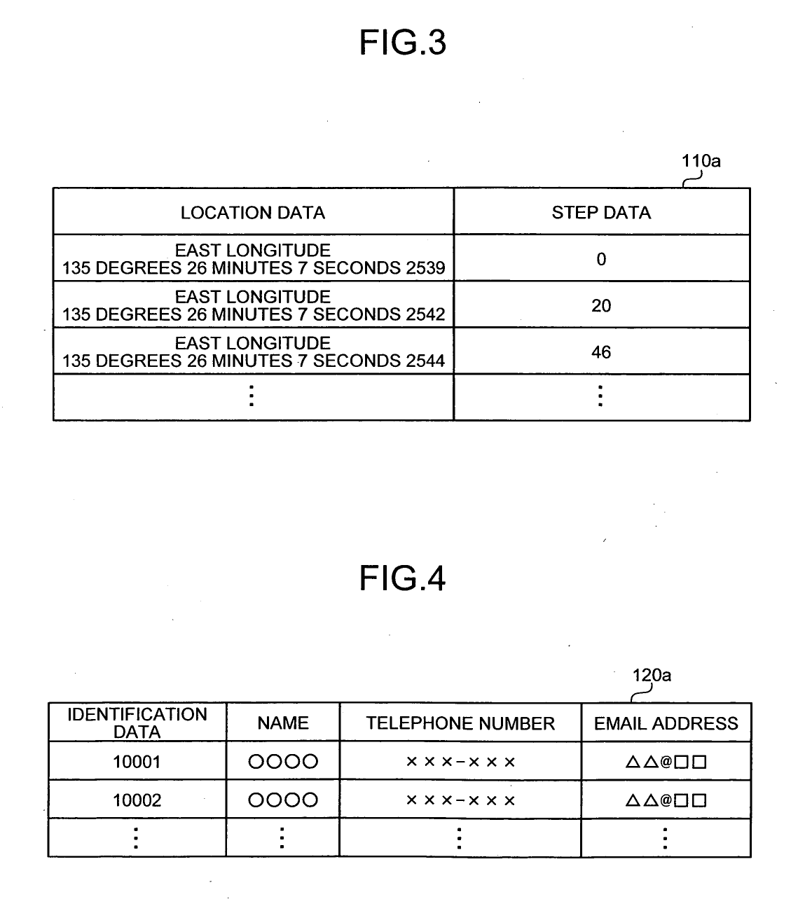

The past-data storage unit 110 stores therein history data (hereinafter, “past data”). FIG. 3 is an example of contents of past data 110a. The past data 110a includes a history of the past location data and a history of the past step data of the child. If the mobile station 100 newly fetches the location data and the step data, the fetched data are recorded in the past data 110a. The latest location data recorded in the past data 110a being equal to the location data that is newly fetched by the mobile station 100 indicates that the child has stopped. The latest location data recorded in the past data 110a differing from the location data that is newly fetched by the mobile station 100 indicates that the child is moving.

The latest step data recorded in the past data 110a being equal to the step data that is newly fetched by the mobile station 100 indicates that the child is not walking. The latest step data recorded in the past data 110a differing from the step data that is newly fetched by the mobile station 100 indicates that the child is walking.

The contact-address storage unit 120 stores therein the data of the emergency contact address (hereinafter, “contact address data”). FIG. 4 is an example of contents of the contact address data 120a. The contact address data 120a includes identification data, name, telephone number, and email address. Upon determining that the child is facing an emergency, the mobile station 100 notifies to a terminal device recorded in the contact address data 120a, data to the effect that the child is facing an emergency.

The counter storage unit 130 stores therein a counter value that indicates a number of continuous instances when the child is not moving and not walking (the mobile station 100 fetches the location data and the step data at predetermined time intervals and determines whether the child is moving and whether the child is walking when fetching the location data and the step data). The counter value exceeding a predetermined value indicates that the child is not moving and not walking for a long time, thus indicating that the child is facing an emergency.

The location-data, fetching unit 140 uses the GPS function to fetch the location data of the child (the location data of the mobile station 100 that is attached to the child) at predetermined time intervals. The location-data fetching unit 140 distributes the fetched location data to the danger detecting unit 170. The location-data fetching unit 140 can also fetch the location data by carrying out communication with the base station.

The step sensor 150 detects swinging of the mobile station 100 that is attached to the child and counts a number of steps of the child. The step sensor function distributes to the danger detecting unit 170, data of the counted number of steps, in other words, the step data.

Similarly as a common mobile phone, the telephone 160 executes various processes (a process to establish a call with another telephone, a process to transceive mails etc.). In a process that is closely related to the present embodiment, if the child is facing an emergency, the telephone 160 notifies to the contact address of the contact address data 120a (see FIG. 4), data to the effect that the child is facing an emergency. The telephone 160 can also notify a monitor (the guardian etc.) that the child is facing an emergency by calling the terminal device that is the contact address and issuing a warning message, or by transmitting a mail to the terminal device that is the contact address.

The danger detecting unit 170 fetches the location data from the location-data fetching unit 140 and fetches the step data from the step sensor 150. The danger detecting unit 170 compares the fetched location data and the step data with the past data 110a that is recorded in the past-data storage unit 110 and determines whether the child is facing an emergency.

A determining process (a process to determine whether the child is facing an emergency) of the danger detecting unit 170 is explained in detail. If the child is moving (if the latest location data recorded in the past data 110a differs from the location data fetched from the location-data fetching unit 140) and the child is not walking (if the latest step data recorded in the past data 110a is equal to the step data fetched from the step sensor 150), the danger detecting unit 170 determines that the child is facing an emergency and distributes the determination result to the telephone 160.

If the child has stopped (if the latest location data recorded in the past data 110a is equal to the location data fetched from the location-data fetching unit 140) and the child is not walking (if the latest step data recorded in the past data 110a is equal to the step data fetched from the step sensor 150), the danger detecting unit 170 adds 1 to the counter value that is stored in the counter storage unit 130 and determines whether the added counter value is exceeding the predetermined value. If the counter value is exceeding the predetermined value, the danger detecting unit 170 determines that the child is facing an emergency and distributes the determination result to the telephone 160.

If the child is moving (if the latest location data recorded in the past data 110a differs from the location data fetched from the location-data fetching unit 140) and the child is walking (if the latest step data recorded in the past data 110a differs from the step data fetched from the step sensor 150), the danger detecting unit 170 determines that the child is not facing an emergency, notifies the determination result to the telephone 160, and returns to an initial value the counter value stored in the counter storage unit 130.

After carrying out the determining process, the danger detecting unit 170 records in the past data 110a of the past-data storage unit 110, the location data fetched from the location-data fetching unit 140 and the step data fetched from the step sensor 150.

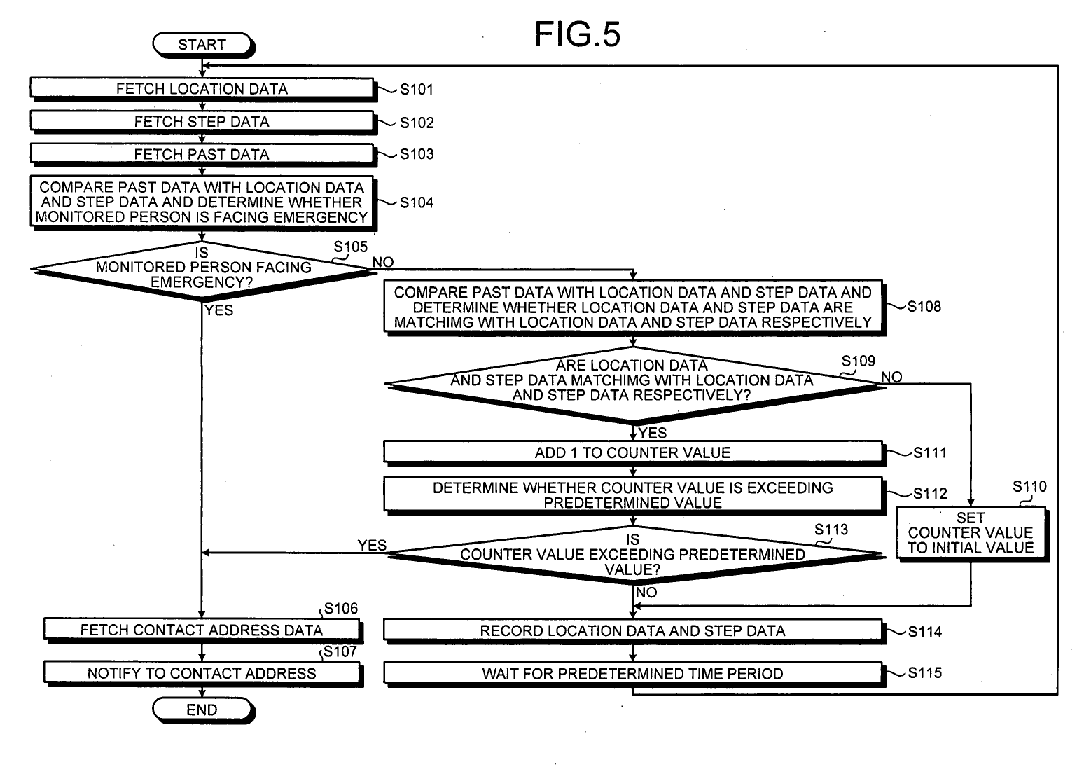

A process of the mobile station 100 according to the present embodiment is explained next. FIG. 5 is a flowchart of a sequence of the process of the mobile station 100 according to the present embodiment. As shown in FIG. 5, the danger detecting unit 170 of the mobile station 100 fetches the location data from the location-data fetching unit 140 (step S101) and fetches the step data from the step sensor 150 (step S102).

Next, the danger detecting unit 170 fetches the past data 110a from the past-data storage unit 110 (step S103). The danger detecting unit 170 compares the location data and the step data of the past data 110a with the location data fetched from the location-data fetching unit 140 and the step data fetched from the step sensor 150 respectively, and determines whether the child is facing an emergency (step S104).

If the danger detecting unit 170 determines that the child is facing an emergency (Yes at step S105), the telephone 160 fetches the contact address data from the contact-address storage unit 120 (step S106) and notifies the contact address of the data to the effect that the child is facing an emergency (step S107).

Upon determining that the child is not facing an emergency (No at step S105), the danger detecting unit 170 determines whether the location data and the step data of the past data 110a match respectively with the location data fetched from the location-data fetching unit 140 and the step data fetched from the step sensor 150 (step S108).

If the location data and the step data of the past data 110a do not match respectively with the location data fetched from the location-data fetching unit 140 and the step data fetched from the step sensor 150 (No at step S109), the danger detecting unit 170 sets the counter value stored in the counter storage unit 130 to the initial value and the process moves to step S114.

If the location data and the step data of the past data 110a match respectively with the location data fetched from the location-data fetching unit 140 and the step data fetched from the step sensor 150 (Yes at step S109), the danger detecting unit 170 adds 1 to the counter value stored in the counter storage unit 130 (step S111) and determines whether the counter value is exceeding the predetermined value (step S112).

If the counter value is exceeding the predetermined value (Yes at step S113), the process moves to step S106. If the counter value is less than the predetermined value (No at step S113), the danger detecting unit 170 records in the past data 110a of the past-data storage unit 110, the location data fetched from the location-data fetching unit 140 and the step data fetched from the step sensor 150 (step S114), and after waiting for a predetermined time period (step S115) the process moves to step S101.

By comparing the location data and the step data with the past data 110a that is recorded in the past-data storage unit 110, the danger detecting unit 170 detects an emergency faced by the child, and notifies the contact address of the emergency faced by the child. Thus, safety of the child can be efficiently protected.

In the mobile station 100 according to the present embodiment, the danger detecting unit 170 fetches the location data from the location-data fetching unit 140, fetches the step data from the step sensor 150, and compares the fetched location data and the step data with the past data 110a recorded in the past-data storage unit 110 to determine whether the child is facing an emergency. If the child is facing an emergency, the telephone 160 notifies the contact address of the contact address data 120a stored in the contact-address storage unit 120 that the child is facing an emergency. Thus, free activities of the child are enabled, and if a danger approaches the child, the emergency faced by the child can be immediately notified to the guardian and safety of the child can be protected.

If a situation in which the child is not moving and not walking continues for more than a predetermined time period, the danger detecting unit 170 of the mobile station 100 according to the present embodiment determines that the child is facing an emergency and notifies the contact address that the child is facing an emergency. Due to this, even if the child is facing an emergency when the mobile station 100 attached to the child is removed (or the mobile station 100 carried by the child is abandoned), the guardian can be notified that the child is facing an emergency.

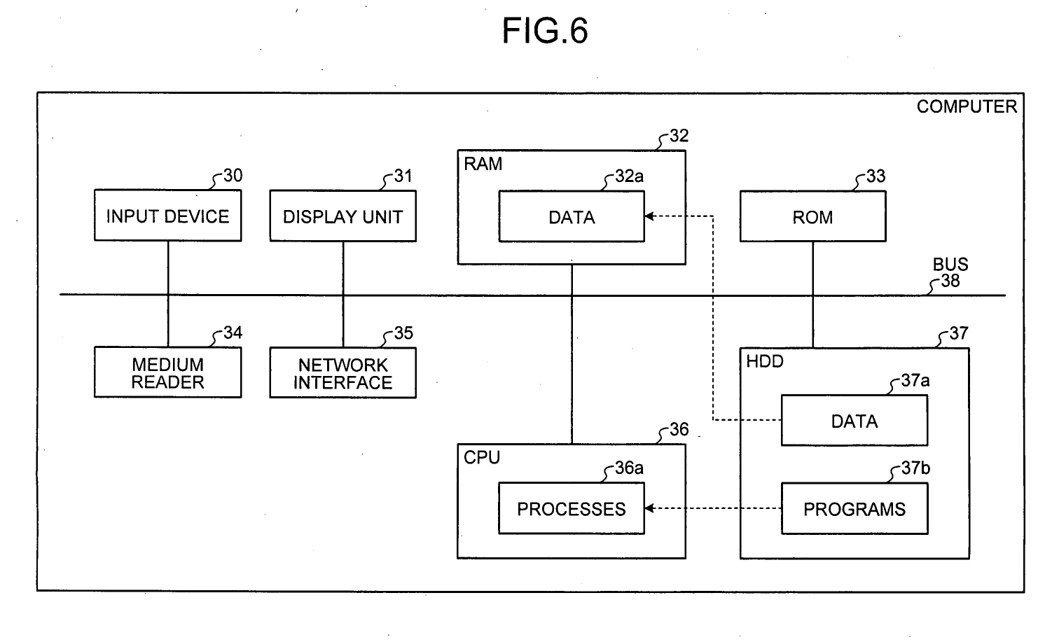

Various processes explained in the embodiment can be realized by executing a prior formulated program using a computer. An example of the computer that executes the program that realizes the processes is explained with reference to FIG. 6.

FIG. 6 is a block diagram of a hardware structure of the computer that implements the mobile station 100 as software. The computer includes an input device 30 that receives an input of data from the user, a display unit 31, a Random Access Memory (RAM) 32, a Read Only Memory (ROM) 33, a medium reader 34 that reads programs from a recording medium that records various programs, a network interface 35 that carries out transfer of data between the computer and another computer via a network, a Central Processing Unit (CPU) 36, and a Hard Disk Drive (HDD) 37 that are connected by buses 38.

The HDD 37 stores therein programs 37b that exhibit functions similar to the functions of the mobile station 100. The CPU 36 reads the programs 37b from the HDD 37 and executes the read programs 37b to activate processes 36a that realize the functions of the functioning units of the mobile station 100.

Further, the HDD 37 stores therein data 37a that corresponds to the data that are stored in the past-data storage unit 110, the contact-address storage unit 120, and the counter storage unit 130 of the mobile station 100. Apart from storing the data 37a in the HDD 37, the CPU 36 reads the data 37a from the HDD 37, stores the read data 37a in the RAM 32, and executes data processes based on data 32a stored in the RAM 32.

The programs 37b need not always be stored in the HDD 37 from the beginning. For example, the programs 37b can be stored in a “portable physical medium” such as a Flexible Disk (FD), a Compact Disk-Read Only Memory (CD-ROM), a Digital Versatile Disk (DVD), a Magneto Optical (MO) disk, an Integrated Circuit (IC) card etc. that is inserted in the computer, a “fixed physical medium” such as an HDD that is included inside or outside the computer, or in “another computer (or a server)” that is connected to the computer via a public line, the Internet, a Local Area Network (LAN), a Wide Area Network (WAN) etc. The computer can read the programs 37b from such media and execute the programs 37b.

Although the invention has been described with respect to a specific embodiment, various modifications may be made without departing from the spirit or scope of the general inventive concept as defined by the appended claims and their equivalents.

All the automatic processes-explained in the embodiment can be, entirely or in part, carried out manually. Similarly, all the manual processes explained in the present embodiment can be entirely or in part carried out automatically by a known method.

The sequence of processes, the sequence of controls, specific names, and data including various parameters can be changed as required unless otherwise specified.

The constituent elements of the device illustrated are merely conceptual and may not necessarily physically resemble the structures shown in the drawings. For instance, the device need not necessarily have the structure that is illustrated. The device as a whole or in parts can be broken down or integrated either functionally or physically in accordance with the load or how the device is to be used.

The process functions performed by the apparatus are entirely or partially realized by the CPU or a program executed by the CPU or by a hardware using wired logic.

According to an embodiment of the present invention, an emergency faced by the monitored person can be detected efficiently, autonomously and in real time while enabling free activities of the monitored person. Moreover, an emergency faced by the monitored person can be detected even if the emergency detecting device attached to the monitored person is removed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An emergency detecting device that detects an emergency faced by a monitored-person, the emergency detecting device comprising:
a fetching unit that fetches location data that indicates current location of the monitored person and step data that indicates a number of steps of the monitored person; and
a determining unit that determines whether the monitored person is facing an emergency based on the location data and the step data.

2. The emergency detecting device according to claim 1, wherein the determining unit analyzes the location data and the step data to check whether the location data and the step data satisfy a first condition that the monitored person is moving but not walking, and upon the first condition being satisfied the determining unit determines that the monitored person is facing an emergency.

3. The emergency detecting device according to claim 1, wherein the determining unit analyzes the location data and the step data to check whether the location data and the step data satisfy a second condition that the monitored person is not moving and a state that the monitored person is not walking continues for more than a predetermined time period, and upon the second condition being satisfied the determining unit determines that the monitored person is facing an emergency.

4. The emergency detecting device according to claim 1, further comprising:
an output unit that outputs to an emergency contact address corresponding to the monitored person, upon the determining unit determining that the monitored person is facing an emergency, data to the effect that the monitored person is facing an emergency.

5. A computer-readable recording medium that stores therein a computer program that causes a computer to detect an emergency faced by a monitored person, the computer program causing the computer to execute:
fetching location data that indicates current location of the monitored person and step data that indicates a number of steps of the monitored person; and
determining whether the monitored person is facing an emergency based on the location data and the step data.

6. The computer-readable recording medium according to claim 5, wherein the determining includes
analyzing the location data and the step data to check whether the location data and the step data satisfy a first condition that the monitored person is moving but not walking; and
upon the first condition being satisfied, determining that the monitored person is facing an emergency.

7. The computer-readable recording medium according to claim 5, wherein the determining includes
analyzing the location data and the step data to check whether the location data and the step data satisfy a second condition that the monitored person is not moving and a state that the monitored person is not walking continues for more than a predetermined time period; and
upon the second condition being satisfied, determining that the monitored person is facing an emergency.

8. A method of detecting an emergency faced by a monitored person, the method comprising:
fetching location data that indicates current location of the monitored person and step data that indicates a number of steps of the monitored person; and
determining whether the monitored person is facing an emergency based on the location data and the step data.

9. The method according to claim 8, wherein the determining includes
analyzing the location data and the step data to check whether the location data and the step data satisfy a first condition that the monitored person is moving but not walking; and
upon the first condition being satisfied, determining that the monitored person is facing an emergency

10. The method according to claim 8, wherein the determining includes
analyzing the location data and the step data to check whether the location data and the step data satisfy a second condition that the monitored person is not moving and a state that the monitored person is not walking continues for more than a predetermined time period; and
upon the second condition being satisfied, determining that the monitored person is facing an emergency.
